(19) United States
(12) Patent Application Publication
(10) Pub. No.: US 2019/0385565 A1
(43) Pub. Date: Dec. 19, 2019

(54) DYNAMIC CONFIGURATION OF DISPLAY FEATURES

(71) Applicant: QUALCOMM Incorporated, San Diego, CA (US)

(72) Inventors: Venkata Nagarjuna Sravan Kumar DEEPALA, Hyderabad (IN); Jayant SHEKHAR, Hyderabad (IN); Raviteja TAMATAM, Hyderabad (IN)

(21) Appl. No.: 16/011,561

(22) Filed: Jun. 18, 2018

(51) Int. Cl. G09G 5/00; G09G 5/10

(52) U.S. Cl. CPC G09G 5/006; G09G 5/10; G09G 2360/145; G09G 2320/0626; G09G 2330/021; G09G 2310/04; G09G 2360/144

(57) ABSTRACT

A method, an apparatus, and a computer-readable medium for wireless communication are provided. In one aspect, an example method may include determining, by a first processing unit, display luminance information and ambient light information. The display luminance information may be indicative of a luminance of a backlight of a display or indicative of pixel luminance of the display. The ambient light information may be indicative of a luminance of ambient light external to the display. The method may include enabling or disabling, by the first processing unit, a first display feature for the display based on the display luminance information and the ambient light information.

### FIELD

The present disclosure relates generally relates to the display processing pipeline.

### BACKGROUND

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes a plurality of processing stages that operate together to execute graphics processing commands/instructions and output a frame. A central processing unit (CPU) may control the operation of the GPU by issuing one or more graphics processing commands/instructions to the GPU. Modern day CPUs are typically capable of concurrently executing multiple applications, each of which may need to utilize the GPU during execution. A device that provides content for visual presentation on a display generally includes a graphics processing unit (GPU).

A GPU renders a frame for display. This rendered frame may be processed by a display processing unit prior to being displayed. For example, the display processing unit may be configured to perform processing on one or more frames that were rendered for display by the GPU and subsequently output the processed frame to a display. The pipeline that includes the CPU, GPU, and DPU may be referred to as a display processing pipeline.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a first processing unit. The first processing unit may be configured to determine display luminance information and ambient light information. The display luminance information may be indicative of a luminance of a backlight of a display or indicative of pixel luminance of the display. The ambient light information may be indicative of a luminance of ambient light external to the display. The first processing unit may be configured to enable or disable a first display feature for the display based on the display luminance information and the ambient light information.

In an aspect of the disclosure, a method, a computer-readable medium, and an apparatus are provided. The apparatus may include a first processing unit. The first processing unit may be configured to determine display luminance information and ambient light information. The display luminance information may be indicative of a luminance of a backlight of a display or indicative of pixel luminance of the display. The ambient light information may be indicative of a luminance of ambient light external to the display. The first processing unit may be configured to enable a first display feature for the display based on the display luminance information and the ambient light information. The first processing unit may be configured to disable a second display feature for the display based on the display luminance information and the ambient light information.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a block diagram that illustrates an example content generation and coding system in accordance with the techniques of this disclosure.

FIG. 1B is a block diagram that illustrates an example configuration between a component of the device depicted in FIG. 1A and a display.

FIG. 1C illustrates an example of ambient light and display luminance operational boundaries in accordance with the techniques described herein.

FIG. 1D illustrates an example of ambient light and display luminance operational boundaries in accordance with the techniques described herein.

FIG. 1E illustrates an example of ambient light and display luminance operational boundaries in accordance with the techniques described herein.

FIGS. 2A-2C illustrate an example flow diagram in accordance with the techniques described herein.

FIG. 3 illustrates an example flowchart of an example method in accordance with one or more techniques of this disclosure.

FIG. 4 illustrates an example flowchart of an example method in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems on a chip (SoC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application (i.e., software) being configured to perform one or more functions. In such examples, it is understood that the application may be stored on a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and executed the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to graphical content or display content. In some examples, as used herein, the term “graphical content” may refer to a content generated by a processing unit configured to perform graphics processing. For example, the term “graphical content” may refer to a content generated by one or more processes of a graphics processing pipeline. In some examples, as used herein, the term “graphical content” may refer to a content generated by a graphics processing unit. In some examples, as used herein, the term “display content” may refer to content generated by a processing unit configured to perform displaying processing. In some examples, as used herein, the term “display content” may refer to a content generated by a display processing unit. In accordance with the techniques described herein, display content may be destined for display in some examples, and may not be destined for display in other examples. Otherwise described, display content may be generated for display in some examples, and display content may be generated that is not for display in other examples. Graphical content may be processed to become display content. For example, a graphics processing unit may output graphical content, such as a frame, to a buffer. A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (i.e., the frame includes two or more layers, and the frame that includes two or more layers may subsequently be blended).

As referenced herein, a first component (e.g., a GPU) may provide content, such as a frame, to a second component (e.g., a display processing unit). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

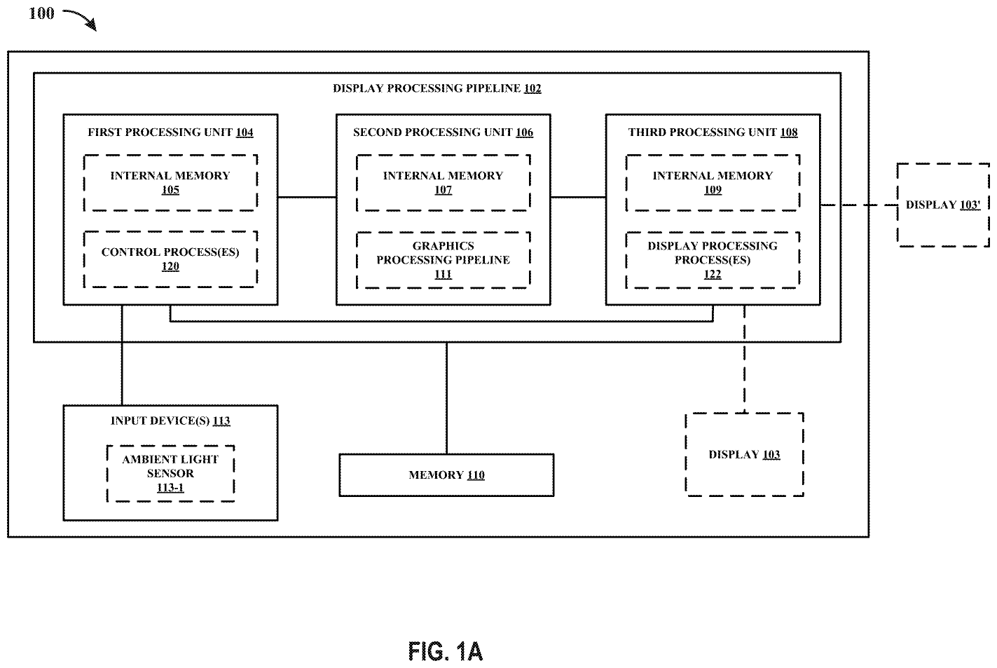

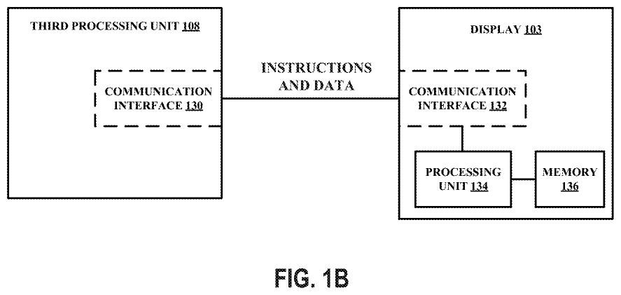

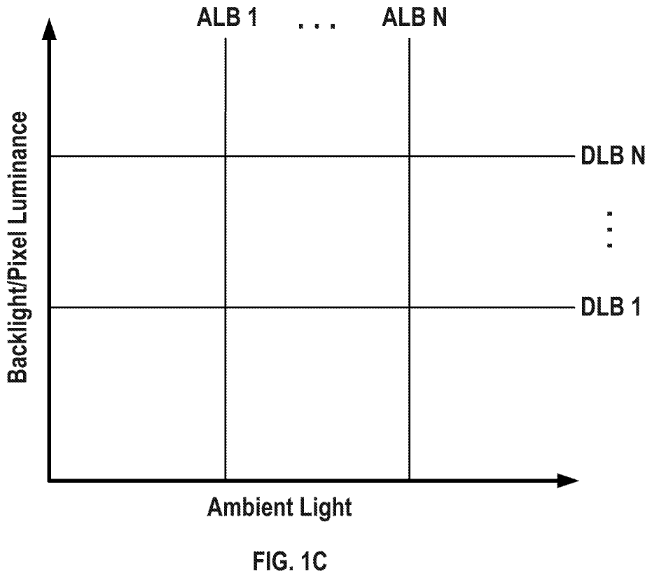

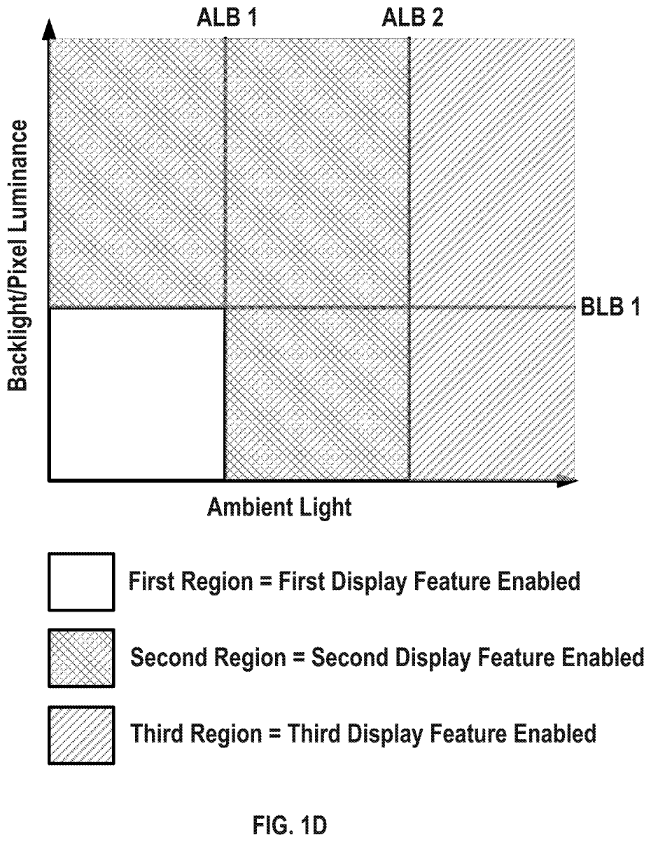

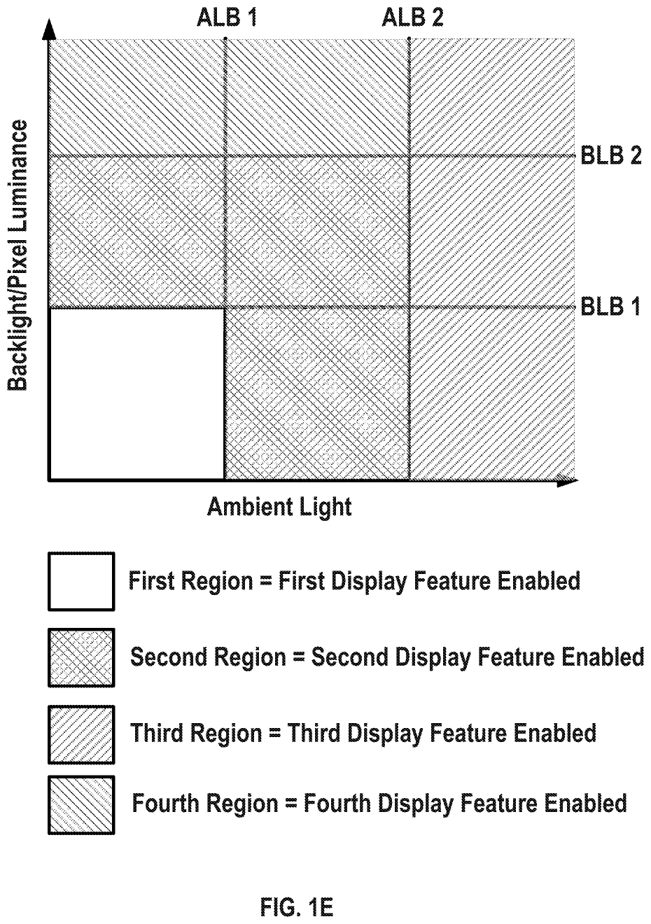

FIG. 1A is a block diagram that illustrates an example device 100 configured to perform one or more techniques of this disclosure. The device 100 includes display processing pipeline 102 configured to perform one or more technique of this disclosure. In accordance with the techniques described herein, the display processing pipeline 102 may be configured to generate content destined for display. The display processing pipeline 102 may be communicatively coupled to a display 103. In the example of FIG. 1A, the display 103 is a display of the device 100. However, in other examples, the display 103 may be a display external to the device 100 (as shown in FIG. 1 with display 103′). Reference to display 103 refers to display 103 or display 103′ (i.e., a display of the device or a display external to the device).

In examples where the display 103 is not external to the device 100, the a component of the device may be configured to transmit or otherwise provide commands and/or content to the display 103 for presentment thereon. In examples where the display 103 is external to the device 100, the device 100 may be configured to transmit or otherwise provide commands and/or content to the display 103 for presentment thereon. As used herein, “commands” and “instructions” may be used interchangeably. In some examples, the display 103 of the device 100 may represent a display projector configured to project content, such as onto a viewing medium (e.g., a screen, a wall, or any other viewing medium). In some examples, the display 103 may include one or more of: a liquid crystal display (LCD), a plasma display, an organic light emitting diode (OLED) display, a projection display device, an augmented reality display device, a virtual reality display device, a head-mounted display, or any other type of display.

The display processing pipeline 102 may include one or more components (or circuits) configured to perform one or more techniques of this disclosure. As used herein, reference to the display processing pipeline being configured to perform any function, technique, or the like refers to one or more components of the display processing pipeline being configured to form such function, technique, or the like.

In the example of FIG. 1A, the display processing pipeline 102 includes a first processing unit 104, a second processing unit 106, and a third processing unit 108. In some examples, the first processing unit 104 may be configured to execute one or more applications, the second processing unit 106 may be configured to perform graphics processing, and the third processing unit 108 may be configured to perform display processing. In such examples, the first processing unit 104 may be a central processing unit (CPU), the second processing unit 106 may be a graphics processing unit (GPU) or a general purpose GPU (GPGPU), and the third processing unit 108 may be a display processing unit, which may also be referred to as a display processor. In other examples, the first processing unit 104, the second processing unit 106, and the third processing unit 108 may each be any processing unit configured to perform one or more feature described with respect to each processing unit.

The first processing unit may include an internal memory 105. The second processing unit 106 may include an internal memory 107. The third processing unit 108 may include an internal memory 109. One or more of the processing units 104, 106, and 108 of the display processing pipeline 102 may be communicatively coupled to an external memory 110. The external memory 110 external to the one or more of the processing units 104, 106, and 108 of the display processing pipeline 102 may, in some examples, be a system memory. The system memory may be a system memory of the device 100 that is accessible by one or more components of the device 100. For example, the first processing unit 104 may be configured to read from and/or write to the external memory 110. The second processing unit 106 may be configured to read from and/or write to the external memory 110. The third processing unit 108 may be configured to read from and/or write to the external memory 110. The first processing unit 104, the second processing unit 106, and the third processing unit 108 may be communicatively coupled to the external memory 110 over a bus. In some examples, the one or more components of the display processing pipeline 102 may be communicatively coupled to each other over the bus or a different connection. In other examples, the system memory may be a memory external to the device 100.

The internal memory 105, the internal memory 107, the internal memory 109, and/or the external memory 110 may include one or more volatile or non-volatile memories or storage devices. In some examples, the internal memory 105, the internal memory 107, the internal memory 109, and/or the external memory 110 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 105, the internal memory 107, the internal memory 109, and/or the external memory 110 may be a non-transitory storage medium according to some examples. The term “non-transitory” may indicate that the storage medium is not embodied in a carrier wave or a propagated signal. However, the term “non-transitory” should not be interpreted to mean that the internal memory 105, the internal memory 107, the internal memory 109, and/or the external memory 110 is non-movable or that its contents are static. As one example, the external memory 110 may be removed from the device 100 and moved to another device. As another example, the external memory 110 may not be removable from the device 100.

In some examples, the first processing unit 104 may be configured to perform any technique described herein with respect to the second processing unit 106. In such examples, the display processing pipeline 102 may only include the first processing unit 104 and the third processing unit 108. Alternatively, the display processing pipeline 102 may still include the second processing unit 106, but one or more of the techniques described herein with respect to the second processing unit 106 may instead be performed by the first processing unit 104.

In some examples, the first processing unit 104 may be configured to perform any technique described herein with respect to the third processing unit 108. In such examples, the display processing pipeline 102 may only include the first processing unit 104 and the second processing unit 106. Alternatively, the display processing pipeline 102 may still include the third processing unit 108, but one or more of the techniques described herein with respect to the third processing unit 108 may instead be performed by the first processing unit 104.

In some examples, the second processing unit 106 may be configured to perform any technique described herein with respect to the third processing unit 108. In such examples, the display processing pipeline 102 may only include the first processing unit 104 and the second processing unit 106. Alternatively, the display processing pipeline 102 may still include the third processing unit 108, but one or more of the techniques described herein with respect to the third processing unit 108 may instead be performed by the second processing unit 106.

The first processing unit 104 may be configured to perform one or more control processes 120 in accordance with the techniques described herein. In some examples, the one or more control processes 120 include any process/operation described herein with respect to the first processing unit 104. For example, the one or more control processes 120 may include one or more of: determining display luminance information, determining ambient light information, enabling any display feature based on display luminance information and/or ambient light information, disabling any display feature based on display luminance information and/or ambient light information, or any process described herein with respect to the first processing unit 104.

The second processing unit 106 may be configured to perform graphics processing in accordance with the techniques described herein, such as in a graphics processing pipeline 111. Otherwise described, the second processing unit 106 may be configured to perform any process described herein with respect to the second processing unit 106.

The third processing unit 108 may be configured to perform one or more display processing processes 122 in accordance with the techniques described herein. For example, the third processing unit 108 may be configured to perform one or more display processing techniques on one or more frames generated by the second processing unit 106 before presentment by the display 103. Otherwise described, the third processing unit 108 may be configured to perform display processing. In some examples, the one or more display processing processes 122 may include one or more of a rotation operation, a blending operation, a scaling operating, any display processing process/operation, or any process/operation described herein with respect to the third processing unit 108. As an example, a display feature described herein may correspond to one or more display processes. For example, the first processing unit 104 may be configured to cause the third processing unit 108 to use a display feature. As another example, the first processing unit 104 may be configured to cause the third processing unit 108 to refrain from using a display feature. Causing the third processing unit to use a display feature may include causing the third processing unit 108 to perform one or more processes corresponding to the display feature. Otherwise described, causing the third processing unit to use a display feature may include causing the third processing unit 108 to perform the display feature. Similarly, causing the third processing unit to refrain from using a display feature may include causing the third processing unit 108 to refrain from performing one or more processes corresponding to the display feature. Otherwise described, causing the third processing unit to refrain from using a display feature may include causing the third processing unit 108 to refrain from performing the display feature.

In some examples, the one or more display processing processes 122 include any process/operation described herein with respect to the third processing unit 108. The display 103 may be configured to display content that was generated using the display processing pipeline 102. For example, the second processing unit 106 may generate graphical content based on commands/instructions received from the first processing unit 104. The graphical content may include one or more layers. Each of these layers may constitute a frame of graphical content. The third processing unit 108 may be configured to perform composition on graphical content rendered by the second processing unit 106 to generate display content. Display content my constitute a frame for display. The frame for display may include two or more layers/frames that were blended together by the third processing unit 108.

The device 100 may include or be connected to one or more input devices 113. In some examples, the one or more input devices 113 includes one or more of: a touch screen, a mouse, a peripheral device, an audio input device (e.g., a microphone or any other visual input device), a visual input device (e.g., a camera, an eye tracker, or any other visual input device), any user input device, or any input device configured to receive an input from a user. In some examples, the display 103 may be a touch screen display; and, in such examples, the display 103 constitutes an example input device 113. In the example of FIG. 1A, the one or more input devices 113 is shown as including an ambient light sensor 113-1. The ambient light sensor 113-1 may be configured to transduce light into information. For example, the ambient light sensor 113-1 may receive light as an input and provide, as an output, ambient light information that is indicative of the luminance of the light received. The ambient light sensor 113-1 may be configured to provide ambient light information to the first processing unit 104. It is understood that the output of an input device may constitute an input to a component receiving the output. In some examples, the ambient light information may be any information output by the ambient light sensor 113-1 representative of the sensed light, such as data, a voltage signal, any signal, or any other information. The ambient light sensor 113-1 may be integrated with the device 100 so that the ambient light sensor 113-1 is configured to detect ambient light external to (e.g., near or otherwise around) the device 100. For example, the ambient light sensor 113-1 may be configured to detect light within a certain distance of the sensor. The ambient light sensor 113-1 may be described as detecting light conditions. The first processing unit 104 may be configured to determine ambient light information based on information received from the ambient light sensor 113-1.

The display processing pipeline 102 may be configured to execute one or more applications. For example, the first processing unit 104 may be configured to execute one or more applications. The first processing unit 104 may be configured to cause the second processing unit 106 to generate content for the one or more applications being executed by the first processing unit 104. Otherwise described, execution of the one or more applications by the first processing unit 104 may cause the generation of graphical content by a graphics processing pipeline. For example, the first processing unit 104 may issue or otherwise provide instructions (e.g., draw instructions) to the second processing unit 106 that cause the second processing unit 106 to generate graphical content based on the instructions received from the first processing unit 104. The second processing unit 106 may be configured to generate one or more layers for each application of the one or more applications executed by the first processing unit 104. Each layer generated by the second processing unit 106 may be stored in a buffer. Otherwise described, the buffer may be configured to store one or more layers of graphical content rendered by the second processing unit 106. The buffer may reside in the internal memory 107 of the second processing unit 106 and/or the external memory 110 (which may be system memory of the device 100 in some examples). Each layer produced by the second processing unit 106 may constitute graphical content. The one or more layers may correspond to a single application or a plurality of applications. The second processing unit 106 may be configured to generate multiple layers of content, meaning that the first processing unit 104 may be configured to cause the second processing unit 106 to generate multiple layers of content.

FIG. 1B is a block diagram that illustrates an example configuration between the third processing unit 108 of the device and the display 103. The third processing unit 108 and the display 103 may be configured to communicate with each other over a communication medium (e.g., a wired and/or wireless communication medium). For example, the third processing unit 108 may include a communication interface 130 (e.g., a bus interface) and the display 103 may include a communication interface 132 (e.g., a bus interface) that enables communication between each other. In some examples, the communication between the third processing unit 108 and the display 103 may be compliant with a communication standard, communication protocol, or the like. For example, the communication between the third processing unit 108 and the display 103 may be compliant with the Display Serial Interface (DSI) standard. In some examples, the third processing unit 108 may be configured to provide data (e.g., content) to the display 103 for presentment thereon. The third processing unit 108 may also be configured to provide commands/instructions to the display 103, such as when the display 103 is a command mode display. The display 103 may include a processing unit 134 and a memory 136 accessible by the processing unit 134. The processing unit 134 may be referred to as a display controller. The memory 136 may be configured to store data that the display 103 receives from the third processing unit 108. For example, the memory 136 may be configured to store (e.g., buffer) frames received from the third processing unit 108. The processing unit 134 may be configured to read data stored in the memory 136 that was received from the third processing unit 108 and drive the display 103 based on one or more commands received from the third processing unit 108.

In some examples, the display 103 may be configured with one or more display features, such as one or more power saving features and/or one or more visibility improvement features. One example of a power saving feature includes a partial update feature. The partial update feature may refer to a technique in which only partial regions of a display are updated with new content relative to the previous frame. For example, a component of the device 100 (e.g., the first processing unit 104 or the third processing unit 108) may be configured to compare a current frame rendered for display to a previously displayed frame. The component of the device 100 may be configured to determine which regions of the current frame differ from the previously displayed frame. The regions that differ may be referred to as dirty regions or regions requiring an update. In some examples, a region may refer to one or more pixels. In other examples, a region may refer to a tile. A tile may include a plurality of pixels. The component of the device 100 may be configured to output the update to the dirty regions or instruct the display to only update the dirty regions. As one example, the component of the device 100 may be configured to only output the content associated with the dirty regions to the display 103. As another example, the component of the device 100 may be configured to output a frame with instruction to the display to only update the display 103 with select regions of the frame. By only updating the dirty regions, power savings is realized because it takes more power to update the entire screen of the display 103 instead of only dirty regions.

Another example of a power saving feature includes a histogram-based feature. One example of a histogram-based feature may include a technique in which a luminance histogram of a frame is determined by a component of the device 100 (e.g., the first processing unit 104 or the third processing unit 108). Otherwise described, the component of the device 100 may be configured to determine a histogram of the luminance of a frame on a per frame basis. The component of the device 100 may be configured to determine, based on the luminance histogram of the frame, whether there are any changes in the content between two frames. Based on the luminance histogram, the device 100 may be configured to adjust the backlight of the display 103 and/or adjust the content itself (e.g., decreasing pixel brightness) through pixel mapping (e.g., using a luminance-based look-up table (LUT)) to save power. As another example, the device 100 may be configured to use the histogram and current display luminance information (e.g., backlight level information and/or brightness setting information), and determine a target (e.g., optimal) backlight level (power saving) while compensating the display 103 with pixel luminance LUT value boosting. As another example, power may be saved (e.g., power consumption may be reduced) by determining (by the device 100, such as by the first processing unit 104 and/or third processing unit 108) a target (e.g., optimal) pixel luminance LUT to alter the brightness of pixels. The pixel luminance LUT may be determined (e.g., by the device 100, such as by the first processing unit 104 and/or the third processing unit 108) in such a way that it preserves the contrast while reducing the pixel brightness, thereby saving power. Otherwise described, a power saving display feature may result in the adjustment of a backlight of the display 103 to a target backlight level and/or may result in the adjustment of pixel luminance using a target pixel luminance LUT for pixel values.

An example of a visibility improvement feature includes a sunlight visibility improvement feature in which a component of the device 100 (e.g., the first processing unit 104 or the third processing unit 108) may be configured to increase the brightness of the display 103 (e.g., by increasing the backlight or increasing pixel brightness).

In accordance with the techniques described herein, power savings may be optimized by dynamically configuring display features based on operational boundaries. For example, power savings may be optimized by dynamically switching between a first power saving feature and a second power saving feature based on operational boundaries. The operational boundaries may include one or more display luminance operational boundaries and one or more ambient light operational boundaries. Otherwise described, optimal power savings may be achieved by intelligently switching between display features (e.g., a partial-update display feature and a luminance histogram-based display feature) based on display luminance information (e.g., display luminance information corresponding to the display 103) and ambient light information. In some examples, a boundary may refer to a threshold value. For example, display luminance information may be indicative of a luminance of a backlight of a display (e.g., the display 103) or indicative of pixel luminance of the display. In some examples, the display 103 may include a backlight. For example, the display 103 may be an Liquid Crystal Display (LCD). In examples where the display 103 includes a backlight, the display luminance information may be indicative of a luminance of the backlight of the display 103. In other examples, the display 103 may not include a backlight. For example, the display 103 may be an organic light-emitting diode (OLED) display, which does not have a backlight. In examples where the display 103 does not include a backlight, the display luminance information may be indicative of pixel brightness (which may be referred to as pixel luminance) of the display 103. Ambient light information may be indicative of a luminance of ambient light external to the display (e.g., the display 103). In some examples, information as described herein may refer to data. Data may represent information. For example, as described above, a boundary may refer to a threshold value. Data may represent this threshold value.

FIG. 1C illustrates an example of ambient light and display luminance operational boundaries. In the example of FIG. 1C, one or more display luminance boundaries are shown, depicted as display luminance boundary 1 (DLB 1) through display luminance boundary N (DLB N), where N is any number. Also in the example of FIG. 1C, one or more ambient light boundaries are shown, depicted as ambient light boundary 1 (ALB 1) through ambient light boundary N (ALB N), where N is any number. A display luminance boundary and/or an ambient light boundary may represent where one or more display features are enabled and/or disabled.

For example, FIG. 1D illustrates an example of ambient light and display luminance operational boundaries with respect to three different display features: a first display feature, a second display feature, and a third display feature. In the example of FIG. 1D, the first display feature may be a first power saving display feature (e.g., a histogram-based display feature), the second display feature may be a second power saving display feature (e.g., a partial update display feature), and the third display feature may be a visibility improvement feature. The boundaries represent where each respective display feature of the first, second, and third display features are enabled or disabled. For example, the first display feature is enabled when the display luminance information is less than DLB 1 and when the ambient light information is less than ALB 1. When the first display feature is enabled, the second and third display features may be disabled. As another example, the second display feature is enabled (1) when the display luminance information is greater than or equal to DLB 1 and when ambient light information is less than ALB 1; and (2) when the ambient light information is greater than or equal to ALB 1 and less than ALB 2 and when the display luminance information is any value. When the second display feature is enabled, the first and third display features may be disabled. As another example, the third display feature is enabled when the ambient light information is greater than or equal to ALB 2 when the display luminance information is any value. When the third display feature is enabled, the first and second display features may be disabled. The display luminance and ambient light value boundaries may change in other examples or may otherwise be adjustable. Another way to describe FIG. 1D is that the first display feature is enabled in the first region and disabled in the second and third regions, the second display feature is enabled in the second region and disabled in the first and third regions, and the third display feature is enabled in the third region and disabled in the first and second regions. In some examples, it is understood that a region of values on one side of a boundary may have values less than or equal to the value corresponding to the boundary, and a region of values on the other side of the boundary may have values greater than the value corresponding to the boundary. In other examples, it is understood that a region of values on one side of a boundary may have values greater than or equal to the value corresponding to the boundary, and a region of values on the other side of the boundary may have values less than the value corresponding to the boundary.

As another example, FIG. 1E illustrates an example of ambient light and display luminance operational boundaries with respect to four different display features: a first display feature, a second display feature, a third display feature, and a fourth display feature. The display luminance and ambient light value boundaries may change in other examples or may otherwise be adjustable.

In accordance with the techniques of this disclosure, one or more of the components of the display processing pipeline 102 is improved and the display processing pipeline 102 is improved. For example, one or more components of the display processing pipeline 102 may be configured to control when one or more display features are used based on display luminance information and ambient light information. By controlling when one or more display features are used, the one or more components of the display processing pipeline 102 control how much power is consumed by, for example, the third processing unit 108 and/or the display 103 (e.g., any component of the display). While one or more display features may increase power consumed by the third processing unit 108 and/or the display 103, one or more other display features may reduce power consumed by the third processing unit 108 and/or the display 103. In accordance with the techniques described herein, power savings may be optimized by dynamically switching between display features based on operational boundaries corresponding to display luminance information and ambient light information. As an example, to reduce the power consumption of the display 103, the first processing unit 104 may cause the third processing unit 108 to perform a first power saving display feature based on a first display luminance boundary and a first ambient light boundary, and perform a second power saving display feature based on those same boundaries. For example, with respect to FIG. 1D, these example boundaries may correspond to DLB 1 and ALB 1.

In some examples, one or more components of the device 100 and/or display processing pipeline 102 may be combined into a single component. For example, one or more components of the display processing pipeline 102 may be one or more components of a system on chip (SoC), in which case the display processing pipeline 102 may still include the first processing unit 104, the second processing unit 106, and the third processing unit 108; but as components of the SoC instead of physically separate components. In other examples, one or more components of the display processing pipeline 102 may be physically separate components that are not integrated into a single component. For example, the first processing unit 104, the second processing unit 106, and the third processing unit 108 may each be a physically separate component from each other. It is appreciated that a display processing pipeline may have different configurations. As such, the techniques described herein may improve any display processing pipeline and/or display, not just the specific examples described herein.

In some examples, one or more components of the display processing pipeline 102 may be integrated into a motherboard of the device 100. In some examples, one or more components of the display processing pipeline 102 may be may be present on a graphics card of the device 100, such as a graphics card that is installed in a port in a motherboard of the device 100 or a graphics card incorporated within a peripheral device configured to interoperate with the device 100.

The first processing unit 104, the second processing unit 106, and/or the third processing unit 108 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. In examples where the techniques described herein are implemented partially in software, the software (instructions, code, or the like) may be stored in a suitable, non-transitory computer-readable storage medium accessible by the processing unit. The processing unit may execute the software in hardware using one or more processors to perform the techniques of this disclosure. For example, one or more components of the display processing pipeline 102 may be configured to execute software. The software executable by the first processing unit 104 may be stored in the internal memory 105 and/or the external memory 110. The software executable by the second processing unit 106 may be stored in the internal memory 107 and/or the external memory 110. The software executable by the third processing unit 108 may be stored in the internal memory 109 and/or the external memory 110.

As described herein, a device, such as the device 100, may refer to any device, apparatus, or system configured to perform one or more techniques described herein. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate content, or any device configured to perform one or more techniques described herein.

As described herein, devices, components, or the like may be described herein as being configured to communicate with each other. For example, one or more components of the display processing pipeline 102 may be configured to communicate with one or more other components of the device 100, such as the display 103, the external memory 110, and/or one or more other components of the device 100 (e.g., one or more input devices). One or more components of the display processing pipeline 102 may be configured to communicate with each other. For example, the first processing unit 104 may be communicatively coupled to the second processing unit 106 and/or the third processing unit 108. As another example, the second processing unit 106 may be communicatively coupled to the first processing unit 104 and/or the third processing unit 108. As another example, the third processing unit 108 may be communicatively coupled to the first processing unit 104 and/or the second processing unit 106.

As described herein, communication may include the communicating of information from a first component to a second component (or from a first device to a second device). The information may, in some examples, be carried in one or more messages. As an example, a first component in communication with a second component may be described as being communicatively coupled to or otherwise with the second component. For example, the first processing unit 104 and the second processing unit 106 may be communicatively coupled. In such an example, the first processing unit 104 may communicate information to the second processing unit 106 and/or receive information from the second processing unit 106.

In some examples, the term “communicatively coupled” may refer to a communication connection, which may be direct or indirect. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. In some examples, a communication connection may enable the communication of information (e.g., the output of information, the transmission of information, the reception of information, or the like). In some examples, the term “communicatively coupled” may refer to a temporary, intermittent, or permanent communication connection.

Any device or component described herein may be configured to operate in accordance with one or more communication protocols. For example, a first and second component may be communicatively coupled over a connection. The connection may be compliant or otherwise be in accordance with a communication protocol. As used herein, the term “communication protocol” may refer to any communication protocol, such as a communication protocol compliant with a communication standard or the like. As an example, a communication protocol may include the Display Serial Interface (DSI) protocol. DSI may enable communication between the third processing unit 108 and the display 103 over a connection, such as a bus.

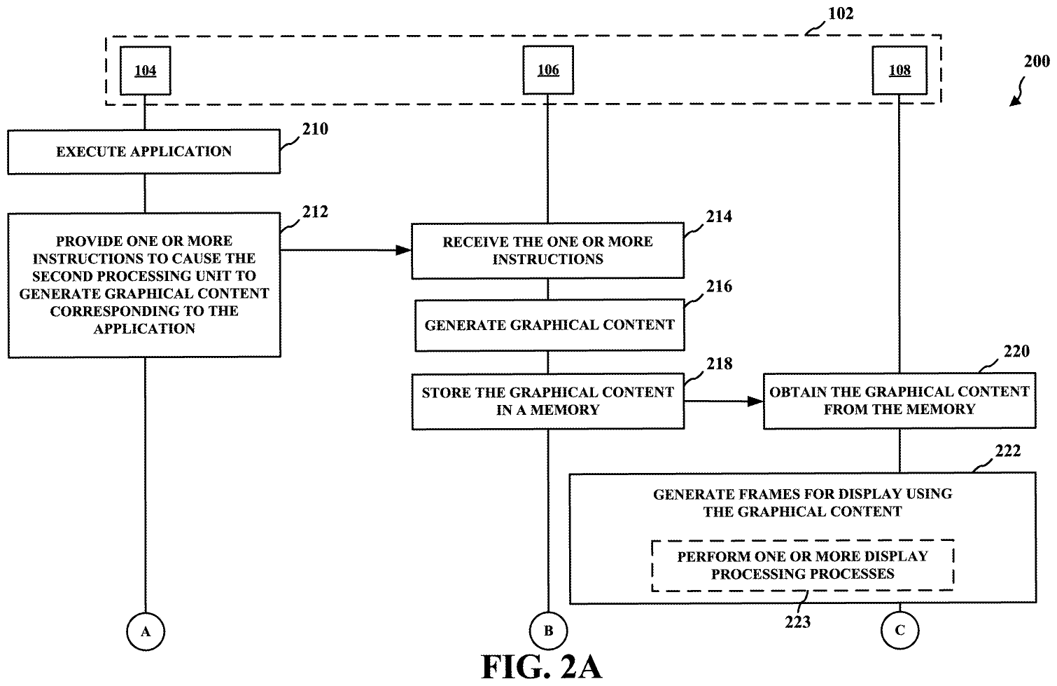

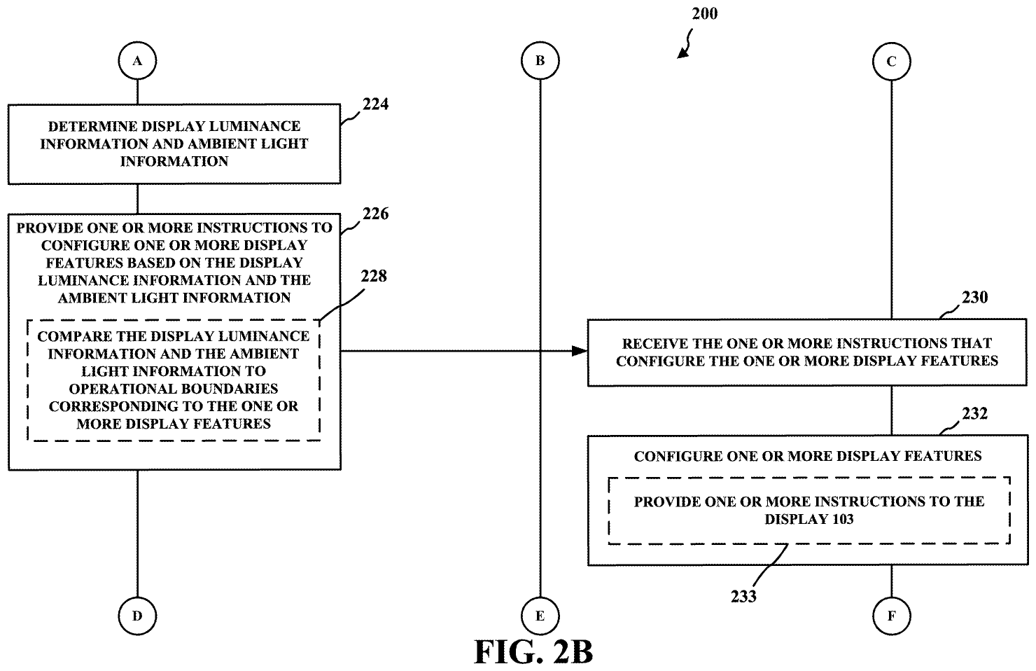

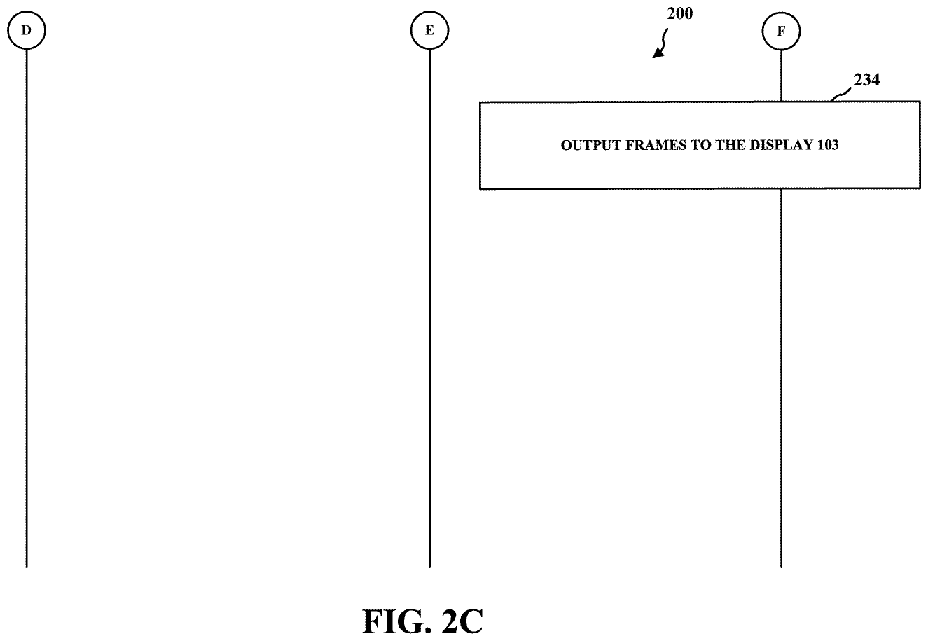

FIGS. 2A-2C illustrate an example flow diagram 200 in accordance with the techniques described herein. In other examples, one or more techniques described herein may be added to the flow diagram 200 and/or one or more techniques depicted in the flow diagram may be removed. One or more blocks shown in FIGS. 2A-C may be performed in parallel.

In the example of FIGS. 2A-C, at block 210, the first processing unit 104 may be configured to execute an application. At block 212, the first processing unit 104 may be configured to provide one or more instructions to the second processing unit 106 to cause the second processing unit 106 to generate graphical content corresponding to the application. At block 214, the second processing unit 106 may be configured to receive the one or more instructions. At block 216, the second processing unit 106 may be configured to generate the graphical content based on the one or more instructions received from the first processing unit 104. The graphical content may include one or more frames. At block 218, the second processing unit 106 may be configured store the generated graphical content in a memory (e.g., the internal memory 107 and/or the external memory 110). For example, the second processing unit 106 may be configured to store each frame of generated graphical content in a memory (e.g., the internal memory 107 and/or the external memory 110).

At block 220, the third processing unit 208 may be configured to obtain the generated graphical content from the memory (e.g., the internal memory 107 and/or the external memory 110). For example, the third processing unit 208 may be configured to obtain one or more frames of generated graphical content from the memory. At block 222, the third processing unit 208 may be configured to generate frames for display using the generated graphical content obtained from the memory. To generate the frame for display, the third processing unit 108 may be configured to perform one or more display processing processes 223 (e.g., composition display processes, such as blending, rotation, or any other composition display process) on the generated first graphical content.

At block 224, the first processing unit 104 may be configured to determine display luminance information and ambient light information. In some examples, to determine the display luminance information, the first processing unit 104 may be configured to receive display luminance information from the third processing unit 108, the display 103, and/or software executing on the first processing unit 104. For example, the first processing unit 104 may be configured to receive display luminance information indicative of display luminance information change events from software that monitors display luminance information changes caused by a user generated input (e.g., display luminance information changes caused by user brightness setting changes) or a system generated input. As another example, the first processing unit 104 may be configured to receive display luminance information indicative of display luminance information scale changes triggered by a display feature described herein. As another example, the first processing unit 104 may be configured to receive display luminance information from any software (e.g., an application, driver, or any other software) executing on the first processing unit 104. Any example of display luminance information may be indicative of at least one of: luminance of a backlight of the display or pixel brightness (which may be referred to as pixel luminance) of the display.

In some examples, display luminance information may be referred to as backlight information and/or pixel luminance information depending on the type of information the display luminance information is indicative of. For example, display luminance information may be indicative of the luminance of a backlight of the display in an example where the display includes a backlight. In this example, the display luminance information may be referred to as backlight information. As another example, display luminance information may be indicative of pixel luminance of the display, such as in an example where the display does not include a backlight. In this example, the display luminance information may be referred to as pixel luminance information. As another example, display luminance information may be indicative of pixel luminance of the display in an example where the display includes a backlight. In such an example, the display luminance information may be indicative of the luminance of a backlight of the display and the pixel luminance of the display. In some examples, reference the pixel luminance of the display may refer to the pixel luminance of pixels that are provided to the display. In other examples, reference the pixel luminance of the display may refer to the luminance of pixels that are presented on the display. In some examples, to determine the ambient light information, the first processing unit 104 is configured to receive information indicative of the luminance of the ambient light external to the display 103.

At block 226, the first processing unit 104 may be configured to provide one or more instructions to the third processing unit 108. The one or more instructions may configure one or more display features based on the display luminance information and the ambient light information. These one or more instructions may be referred to as one or more display feature configuration instructions. In some examples, configuration of a display feature may include the enabling or disabling of the display feature. Enabling a display feature may include causing, by the first processing unit 104, the third processing unit 108 to use the first display feature. Disabling a display feature may include causing, by the first processing unit 104, the third processing unit 108 to refrain from using the display feature. For example, the third processing unit 108 may be configured to receive the one or more display feature configuration instructions to configure the one or more display features at block 230.

While blocks 224, 226, and 228 are shown relative to the other blocks in FIGS. 2A-C, it is understood that blocks 224, 226, and 228 may occur in parallel with the other blocks shown in FIGS. 2A-C. In some examples, blocks 224, 226, and 228 may be referred to as a display feature configuration routine. In other examples, the blocks 224, 226, and 228 constitute example processes of control processes 120.

In some examples, to provide one or more display feature configuration instructions to the third processing unit 108 based on display luminance information and ambient light information, the first processing unit 104 may be configured to compare the determined display luminance information and the determined ambient light information to operational boundaries corresponding to the one or more display features. For example, with respect to FIG. 1D, the determined display luminance information may correspond to a first display luminance value (e.g., a backlight luminance value or a pixel luminance value), the DLB 1 may correspond to a second display luminance value, the determined ambient light information may correspond to a first ambient light value, the ALB 1 may correspond to a second ambient light value, and the ALB 2 may correspond to a third ambient light value. The first processing unit 104 may be configured to compare the first display luminance value to all display luminance boundaries (there is only one display luminance boundary in the example of FIG. 1D) and the first ambient light value to all ambient light boundaries to determine which display feature to enable and which display features to disable. The display feature to enable is the display feature that is used in the region within which the first display luminance value and the first ambient light value are located. For example, if the first display luminance value is less than the second display luminance value and the first ambient light value is less than the second ambient light value, then the display feature to be enabled would be the first display feature (and the display features to be disabled include the second and third display features). As another example, if the first display luminance value and the first ambient light value are determined to fall within the second region based on the comparison, then the display feature to be enabled would be the second display feature (and the display features to be disabled include the first and third display features). In accordance with the techniques described herein, when the display luminance information and the ambient light information moves from a first region corresponding to a first display feature to a second region corresponding to a second display feature, the first processing unit 104 may be configured to switch the display feature being used by the third processing unit 108 and the display 103. In this example, the first processing unit 104 may be configured to disable the first display feature and enable the second display feature as a result of the display luminance information and the ambient light information entering the second region (e.g., a region of display luminance values and ambient light values in which the second display feature is to be used).

At block 232, the third processing unit 108 may be configured to configure one or more display features of the display 103 based on the one or more display feature configuration instructions received at block 230. In some examples, to configure the one or more display features of the display 103, the third processing unit 108 is configured to provide one or more instructions to the display 103. The processing unit 134 may be configured to receive the one or more instructions provided by the third processing unit 108. Based on the one or more instructions, the processing unit 134 may cause the display 103 (e.g., the processing unit 134 of the display) to use or refrain from using one or more display features to update the display with frames received from the third processing unit 108.

In some examples, one or more display features may be configured on a per frame basis. Otherwise described, for each frame provided to the display 103 for display, corresponding one or more instructions may be provided to the display 103 to cause one or more display features to be configured on a per frame basis. In other examples, one or more display features may be configured when operational boundaries change. Otherwise described, corresponding one or more instructions may be provided to the display 103 to cause one or more display features to be configured when the display luminance information and ambient light information results in different display feature needing to be configured.

In some examples, to configure the one or more display features, the third processing unit 108 may be configured to provide one or more instructions to the display 103 at block 233. At block 234, the third processing unit 108 may be configured to output frames to the display 103. Otherwise described, after configuring the display 103 with one or more display features, the third processing unit 108 may be configured to output one or more frames to the display 103 for display, such as in accordance with an enabled display feature. The enabled display feature may cause the first processing unit 104 and/or the third processing unit 108 to output a target backlight level and/or a target luminance LUT for a frame or a plurality of frames.

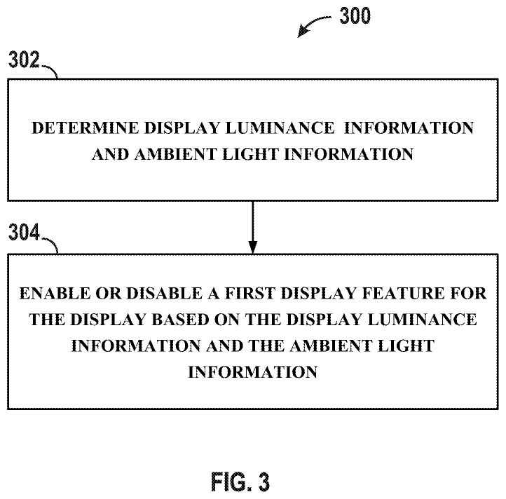

FIG. 3 illustrates an example flowchart 300 of a method in accordance with one or more techniques of this disclosure. The method may be performed by one or more components of a first apparatus. The first apparatus may, in some examples, be the device 100. In some examples, the method illustrated in flowchart 300 may include one or more functions described herein that are not illustrated in FIG. 3, and/or may exclude one or more illustrated functions.

At block 302, a processing unit of the first apparatus may be configured to determine display luminance information and ambient light information. The display luminance information may be indicative of a luminance of a backlight of a display or indicative of pixel luminance of the display. The ambient light information may be indicative of a luminance of ambient light external to the display. At block 304, the processing unit may be configured to enable or disable a first display feature for the display based on the display luminance information and the ambient light information.

In some examples, to determine the ambient light information, the processing unit is configured to receive, from an input device, data or a signal indicative of the luminance of the ambient light external to the display. In such examples, the data or the signal may be the ambient light information.

In some examples, the first display feature may be a power saving feature. The power saving feature may be a partial update feature or a histogram-based feature. In examples where the power saving feature is a histogram-based feature, the histogram-based feature is a feature in which the processing unit may be configured to determine a luminance histogram of a frame.

In some examples, the first display feature may be a visibility improvement feature. In such examples, the visibility improvement feature be a sunlight visibility improvement feature.

In some examples, the processing unit may be configured to enable or disable a second display feature for the display based on the display luminance information and the ambient light information. In such examples, the first display feature and the second display feature may not be enabled at the same time. The first display feature may be a first power saving feature and the second display feature may be a second power saving feature. To enable the first display feature, the processing unit may be configured to cause a display processing unit to use the first display feature. To disable the first display feature, the processing unit may be configured to cause a display processing unit to refrain from using the first display feature.

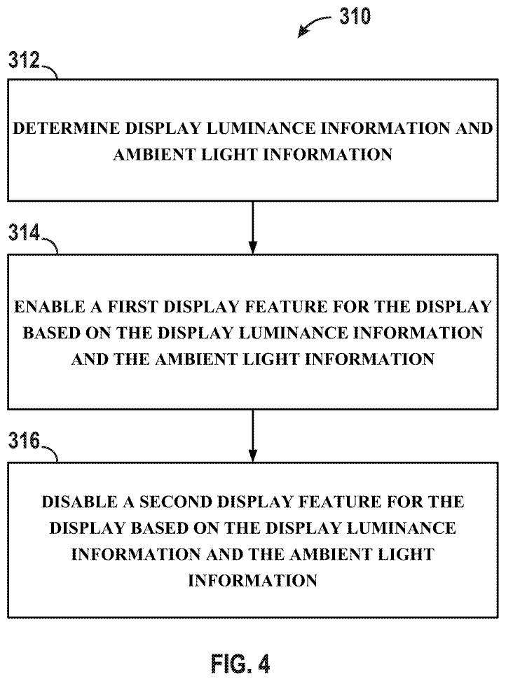

FIG. 4 illustrates an example flowchart 310 of a method in accordance with one or more techniques of this disclosure. The method may be performed by one or more components of a first apparatus. The first apparatus may, in some examples, be the device 100. In some examples, the method illustrated in flowchart 310 may include one or more functions described herein that are not illustrated in FIG. 4, and/or may exclude one or more illustrated functions.

At block 312, a processing unit of the first apparatus may be configured to determine display luminance information and ambient light information. The display luminance information may be indicative of a luminance of a backlight of a display or indicative of pixel luminance of the display. The ambient light information may be indicative of a luminance of ambient light external to the display. At block 314, the processing unit may be configured to enable a first display feature for the display based on the display luminance information and the ambient light information. At block 316, the processing unit may be configured to enable a first display feature for the display based on the display luminance information and the ambient light information.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, it is understood that such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
determining, by a first processing unit, display luminance information and ambient light information, wherein the display luminance information is indicative of a luminance of a backlight of a display or indicative of pixel luminance of the display, and wherein the ambient light information is indicative of a luminance of ambient light external to the display;
enabling or disabling, by the first processing unit, a first display feature for the display based on the display luminance information and the ambient light information.

2. The method of claim 1, wherein determining the ambient light information comprises receiving, by the first processing unit from an input device, data or a signal indicative of the luminance of the ambient light external to the display.

3. The method of claim 2, wherein the data or the signal is the ambient light information.

4. The method of claim 1, wherein the first display feature is a power saving feature.

5. The method of claim 4, wherein the power saving feature is a partial update feature or a histogram-based feature.

6. The method of claim 5, wherein the histogram-based feature is a feature in which the first processing unit is configured to determine a luminance histogram of a frame.

7. The method of claim 1, wherein the first display feature is a visibility improvement feature.

8. The method of claim 7, wherein the visibility improvement feature is a sunlight visibility improvement feature.

9. The method of claim 1, further comprising:
enabling or disabling, by the first processing unit, a second display feature for the display based on the display luminance information and the ambient light information.

10. The method of claim 9, wherein the first display feature and the second display feature are not enabled at the same time.

11. The method of claim 9, wherein the first display feature is a first power saving feature and the second display feature is a second power saving feature.

12. The method of claim 1, wherein enabling the first display feature comprises causing, by the first processing unit, a display processing unit to use the first display feature, and wherein disabling the first display feature comprises causing, by the first processing unit, the display processing unit to refrain from using the first display feature.

13. The method of claim 12, wherein a device includes:
the first processing unit;
the display processing unit, and
the display.

14. The method of claim 13, wherein the first processing unit is a central processing unit (CPU).

15. A first processing unit configured to:
determine display luminance information and ambient light information, wherein the display luminance information is indicative of a luminance of a backlight of a display or indicative of pixel luminance of the display, and wherein the ambient light information is indicative of a luminance of ambient light external to the display;
enable or disable a first display feature for the display based on the display luminance information and the ambient light information.

16. The first processing unit of claim 15, wherein to determine the ambient light information, the first processing unit is configured to receive, from an input device, data or a signal indicative of the luminance of the ambient light external to the display.

17. The first processing unit of claim 16, wherein the data or the signal is the ambient light information.

18. The first processing unit of claim 15, wherein the first display feature is a power saving feature.

19. The first processing unit of claim 18, wherein the power saving feature is a partial update feature or a histogram-based feature.

20. The first processing unit of claim 19, wherein the histogram-based feature is a feature in which the first processing unit is configured to determine a luminance histogram of a frame.

21. The first processing unit of claim 15, wherein the first display feature is a visibility improvement feature.

22. The first processing unit of claim 21, wherein the visibility improvement feature is a sunlight visibility improvement feature.

23. The first processing unit of claim 15, further configured to:
enable or disable a second display feature for the display based on the display luminance information and the ambient light information.

24. The first processing unit of claim 23, wherein the first display feature and the second display feature are not enabled at the same time.

25. The first processing unit of claim 23, wherein the first display feature is a first power saving feature and the second display feature is a second power saving feature.

26. The first processing unit of claim 15, wherein to enable the first display feature, the first processing unit is configured to cause a display processing unit to use the first display feature; and wherein to disable the first display feature, the first processing unit is configured to cause the display processing unit to refrain from using the first display feature.

27. The first processing unit of claim 26, wherein a device includes:
the first processing unit;
the display processing unit, and
the display.

28. The first processing unit of claim 15, wherein the first processing unit is a central processing unit (CPU).

29. A method comprising:
determining, by a first processing unit, display luminance information and ambient light information, wherein the display luminance information is indicative of a luminance of a backlight of a display or indicative of pixel luminance of the display, and wherein the ambient light information is indicative of a luminance of ambient light external to the display;
enabling, by the first processing unit, a first display feature for the display based on the display luminance information and the ambient light information; and
disabling, by the first processing unit, a second display feature for the display based on the display luminance information and the ambient light information.

30. A first processing unit configured to:
determine display luminance information and ambient light information, wherein the display luminance information is indicative of a luminance of a backlight of a display or indicative of pixel luminance of the display, and wherein the ambient light information is indicative of a luminance of ambient light external to the display;
enable a first display feature for the display based on the display luminance information and the ambient light information; and
disable a second display feature for the display based on the display luminance information and the ambient light information.
